(19) United States
(12) Patent Application Publication
(10) Pub. No.: US 2019/0050735 A1
(43) Pub. Date: Feb. 14, 2019

(54) METHODS AND ALGORITHMS OF REDUCING COMPUTATION FOR DEEP NEURAL NETWORKS VIA PRUNING

(71) Applicant: Samsung Electronics Co., Ltd., Suwon-si (KR)

(72) Inventors: Zhengping JI, Temple City, CA (US); John Wakefield BROTHERS, Calistoga, CA (US); Weiran DENG, Woodland Hills, CA (US); Georgios GEORGIADIS, Burbank, CA (US)

(21) Appl. No.: 15/724,267

(22) Filed: Oct. 3, 2017

Related U.S. Application Data
(60) Provisional application No. 62/544,741, filed on Aug. 11, 2017.

(51) Int. Cl. G06N 3/08; G06N 3/04

(52) U.S. Cl. CPC G06N 3/082; G06N 3/0472

(57) ABSTRACT

A method is disclosed to reduce computational load of a deep neural network. A number of multiply-accumulate (MAC) operations is determined for each layer of the deep neural network. A pruning error allowance per weight is determined based on a computational load of each layer. For each layer of the deep neural network: a threshold estimator is initialized, and weights of each layer are pruned based on a standard deviation of all weights within the layer. A pruning error per weight is determined for the layer, and if the pruning error per weight exceeds a predetermined threshold, the threshold estimator is updated for the layer the weights of the layer are repruned using the updated threshold estimator and the pruning error per weight is re-determined until the pruning error per weight is less than the threshold. The deep neural network is then retrained.

### CROSS-REFERENCE TO RELATED APPLICATION

This patent application claims the priority benefit under 35 U.S.C. § 119(e) of U.S. Provisional Patent Application No. 62/544,741, filed on Aug. 11, 2017, the disclosure of which is incorporated herein by reference in its entirety.

### TECHNICAL FIELD

The subject matter disclosed herein generally relates to neural networks, and more particularly, to a technique for pruning parameters of a neural network to reduce the computational load of the neural network.

### BACKGROUND

Deep-learning architectures, such as convolutional deep neural networks, have been widely used in artificial intelligence (AI) and computer-vision fields to produce state-of-the-art results for tasks such as visual object recognition, detection and segmentation. The main efforts of deep learning have been focused on the software implementation with respect to network architectures, learning algorithms and applications. Yet the hardware implementation to provide a more powerful on-board performance is still limited. A major challenge for deep-learning hardware lies in the huge number of parameters contained within the deep neural networks, which causes high computational loads and results in large power consumption.

One approach to reduce the computation of deep-learning neural networks is to prune a neural network by setting many of the parameters to be equal to zero, thereby allowing many multiply-accumulate (MAC) operations to be skipped and reducing the power consumed by the neural network. Nevertheless, a significant challenge is how to set a good pruning threshold for each layer of a deep neural network for an overall minimal computational load, while maintaining original neural network performance. For a deep-neural network composed of dozens of layers, a brute-force search technique for a threshold toward a globally minimized computation is not practical, especially considering that the threshold for one layer might be dependent on the threshold of other layers. Additionally, pruning may require the retraining of the network to recover to original network performance such that the pruning process takes considerable time to be verified as being effective.

### SUMMARY

An example embodiment provides a method to reduce computational load of a deep neural network that may include: determining a number of multiply-accumulate (MAC) operations for each layer l of the deep neural network, the deep neural network may include a plurality of layers; determining a pruning error allowance per weight ε* based on a computational load of a layer l; for each layer l of the deep neural network; initializing a threshold estimator Tₗ; pruning weights of the layer l based on a standard deviation of all weights within the layer l; determining a pruning error per weight ε for the layer l; if |ε−ε|>θ, updating the threshold estimator Tₗ for the layer l in which θ is a predetermined number defining a range centered on the pruning error allowance per weight ε*, then
repruning weights of the layer l using the updated threshold estimator Tₗ, and re-determining the pruning error weight ε until |ε−ε*|≤θ for the layer l; and if |ε−ε*|≤θ, retraining the deep neural network. In one embodiment, the method may further include after retraining the deep neural network, adjusting the threshold estimator Tₗ for each layer based on a MAC percentage value and a pruning percentage value; and repruning and retraining the deep neural network. In one embodiment, determining the pruning error allowance per weight ε* based on the computational load of a layer l may include determining the pruning error allowance per weight ε* as

$${ɛ}^{*} = C + β \frac{{M}_{l}}{{\sum }_{l} {M}_{l}} ,$$

in which C is a constant and β is a weight value. In another embodiment, pruning weights of the layer l based on the standard deviation of all weights within the layer l may include pruning the weights of the layer l as

$${w}_{i} = \{ \begin{matrix}0 , & if \vert {w}_{i} \vert < {T}_{l} σ ( w ) \\ {w}_{i} , & else\end{matrix} ,$$

in which wᵢ is a weight of layer l, σ(w) is a standard deviation of all weights within a layer l, and w is a weight vector. In still another embodiment, determining the pruning error per weight e may include determining ε as

$$ɛ = \frac{{‖ {w}_{pruned} - w ‖}_{1}}{\vert 1 \{ wpruned == 0 \} \vert} .$$

In yet another embodiment, updating the threshold estimator Tₗ may include updating the threshold estimator Tₗ as:

$${T}_{l} = \{ \begin{matrix}{T}_{l} + ζ , & if ɛ > {ɛ}^{*} + θ \\ {T}_{l} - ζ , & if ɛ < {ɛ}^{*} - θ\end{matrix} ,$$

in which ζ is a predetermined number by which the threshold estimator Tₗ may change.

### BRIEF DESCRIPTION OF THE DRAWINGS

In the following section, the aspects of the subject matter disclosed herein will be described with reference to exemplary embodiments illustrated in the figures, in which:

FIG. 1 is a flow diagram for an example embodiment of an automatic layer-wise pruning process to reduce the parameters within a deep neural network according to the subject matter disclosed herein.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail not to obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not be necessarily all referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. Similarly, various waveforms and timing diagrams are shown for illustrative purpose only. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing particular exemplary embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement the teachings of particular embodiments disclosed herein.

Unless otherwise defined, all terms (including technical and scientific terms) used herein have the same meaning as commonly understood by one of ordinary skill in the art to which this subject matter belongs. For example, the term “mod” as used herein means “modulo.” It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Pruning of a neural network may be performed with a goal of reducing the amount of computation associated with the neural network by setting parameters to be equal to zero and thereby allowing many of the MAC operations to be skipped because the result of the MAC operation would be zero. Typically, convolutional layers have the largest number of MAC operations, so when pruning is performed to reduce computational load, the convolutional layers are generally pruned the most. Pruning may also be performed with a goal of reducing the size of the neural network, that is, maximize the sparsity of layers of a neural network having the most parameters. Typically, fully connected (FC) layers have the largest number of parameters, so when pruning to reduce the size of a neural network, the FC layers are generally pruned the most.

In one embodiment, the subject matter disclosed herein minimizes overall network computation by providing an automatic layer-wise pruning process to reduce the number of parameters from convolutional layers in a neural network so that the neural network has a reduced number of MAC operations, which also reduces power consumption for the hardware of the neural network, while maintaining good performance for tasks such as, but not limited to, image-recognition. Additionally, the subject matter disclosed herein provides a technique in which pruning thresholds may be adapted after a predetermined number of training iterations.

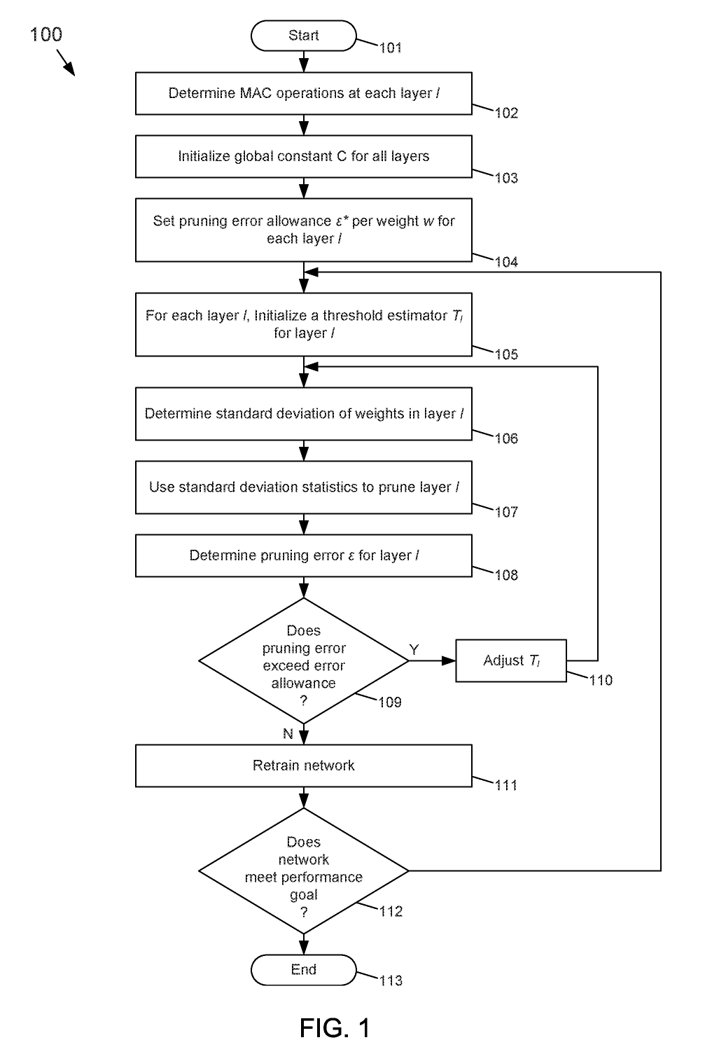

FIG. 1 is a flow diagram for an example embodiment of an automatic layer-wise pruning process 100 to reduce the parameters within a deep neural network according to the subject matter disclosed herein. The pruning process 100 may be performed using a general-purpose computer as a neural network is being tuned. The process 100 starts at 101. At 102, the number Mₗ of MAC operations at each layer l of a deep neural network is determined.

At 103, a global constant C is initialized for all layers. In one embodiment, the global constant C is selected based on empirical rules. In one embodiment, the global constant C may be selected to as an average acceptable error included by each layer in which the error is measured by the squared error between the original and the pruned layer.

At 104, a pruning error allowance ε* per weight w is selected based on the computational load of layer l, as

$${ɛ}^{*} = C + β \frac{{M}_{l}}{{\sum }_{l} {M}_{l}} . \qquad ( 1 )$$

At 105, for each layer l, initialize a threshold estimator Tₗ. In one embodiment, the threshold estimator Tᵢ may be selected based on empirical rules. In one embodiment, the threshold estimator Tᵢ may be selected to be a small value, such as, Tᵢ=0.01. It should be noted that the selected value for Tᵢ is quickly iterated until the correct value is found. Each iteration is fast to compute, so the amount of time it takes to converge to an optimal solution is short. While original value of the threshold estimator Tᵢ selected affects only the number of steps needed to reach an optimal solution, it takes very little time to converge to the optimal solution.

At 106, the standard deviation σ(w) of all of the weights w in layer l is determined in which w is a weight vector.

At 107, the weights in layer l are pruned, i.e., set equal to 0, if the absolute value of a weight w is less than Tₗσ(w) For the weight vector w, each element is defined as

$${w}_{i} = \{ \begin{matrix}0 , & if \vert {w}_{i} \vert < {T}_{l} σ ( w ) \\ {w}_{i} , & else\end{matrix} . \qquad ( 2 )$$

At 108, the pruning error per weight ε is determined. In one embodiment, the pruning error per weight ε may be the squared error between the original and the pruned layer divided by the number of weights that have been pruned (i.e., the number of weights that equal 0). That is, the pruning error per weight ε may be determined as

$$ɛ = \frac{{‖ {w}_{pruned} - {w}_{l} ‖}_{2}}{\vert 1 \{ wpruned == 0 \} \vert} . \qquad ( 3 )$$

At 109, it is determined whether the pruning error per weight ε determined at 108 is less than the pruning error allowance ε* per weight w in which θ is a predetermined number defining a range centered on the pruning error allowance ε* per weight w. That is, at 109 it is determined whether

|ε−ϵ*|>θ. (4)

If, at 109, the pruning error per weight ε is determined to be greater than or equal to the pruning error allowance ε* per weight w, flow continues to 110 where the threshold estimator Tₗ is adjust as

$${T}_{l} = \{ \begin{matrix}{T}_{l} + ζ , & if ɛ < {ɛ}^{*} - θ \\ {T}_{l} - ζ , & if ɛ > {ɛ}^{*} + θ\end{matrix} , \qquad ( 5 )$$

in which ζ is a constant selected by which the threshold estimator Tₗ may change. Flow then returns to 106.

If, at 109, the pruning error per weight ε is determined to be less than the pruning error allowance ε* per weight w, flow continues to 111 where the deep neural network is retrained.

At 112, it is determined whether the pruned network meets a defined performance goal. If not, flow returns to 105, and the process is repeated until the network meets the defined performance goal. If, at 112, it is determined that the pruned network meets the defined performance goal, flow continues to 113 where the method ends. In an alternative embodiment, at 112 it may be determined whether a predetermined number of pruning/training iterations have been performed and, if so, flow continues to 113 where the process ends.

Table 1 sets forth example results of pruning GoogLeNet, a 22-layer deep neural network using the automatic layer-wise pruning process disclosed herein.

TABLE 1
Example Results of Pruning GoogLeNet Neural Network

| | | | Pruning to |
|---|---|---|---|
| | | Pruning to | minimize MAC |
| | Original Network | minimize size | operation |
| # of | 6,990,272 | 2,432,442 | 2,584,415 |
| Parameters | | | |
| # of MAC | 1,584,534,656 | 782,321,192 | 482,012,128 |
| operations | | | |
| Pruning | 100.00% | 34.80% | 36.97% |
| rate | | | |
| MAC rate | 100.00% | 49.37% | 30.42% |
| Retraining | 68.93% | 68.76% | 68.85% |
| top-1 | | | |
| rate | | | |
| Retraining | 89.15% | 89.11% | 89.02% |
| top-5 | | | |
| rate | | | |

As set forth in Table 1, the original GoogLeNet neural network includes 6,990,272 parameters, 1,584,534,656 MAC operations. If the GoogLeNet neural network is pruned to minimize network size, the number of parameters remaining after pruning is 2,432,442 parameters and the resulting number of MAC operations is 782,321,192 operations. That results in 34.80% of the parameters (Pruning rate), and 49.37% of the MAC operations (MAC rate) remaining in the pruned network. As shown in Table 1, the retraining top-1 rate and the retraining top-5 rate of the network pruned to reduce size closely matches the unpruned network.

If the GoogLeNet neural network is pruned using the automatic layer-wise pruning process disclosed herein to minimize the number of MAC operations, the number of parameters remaining after pruning is 2,584,415 parameters and the resulting number of MAC operations is 482,012,128 operations. That results in 36.97% of the parameters (Pruning rate), and 30.42% of the MAC operations (MAC rate) remaining in the pruned network. As shown in Table 1, the retraining top-1 rate and the retraining top-5 rate of the network pruned to reduce MAC operations closely matches the unpruned network.

Table 2 sets forth example results of pruning a scene segment neural network using the automatic layer-wise pruning process disclosed herein.

TABLE 2
Example Results of Pruning a scene segment Neural Network

| | | Original | | | |
|---|---|---|---|---|---|
| | | network | Setup I | Setup II | Setup III |
| # of Parameters | | 9,356,616 | 2,864,794 | 3,553,108 | 5,538,019 |
| # MAC operations | | 71,994,425,260 | 35,808,882,068 | 40,771,486,260 | 39,568,340,540 |
| Pruning Rate | | 100% | 30.62% | 37.97% | 59.19% |
| MAC Rate | | 100% | 49.74% | 56.63% | 54.96% |
| Performance | IoU | 75.7% | 74.3% | 75.2% | 75.2% |
| | iIoU | 52.4% | 51.0% | 51.7% | 51.6% |
| | IoU_c | 88.0% | 87.7% | 87.8% | 87.9% |
| | iIoU_c | 72.7% | 71.7% | 71.9% | 72.2% |

Table 2 sets forth four pruning results (setups) of an example scene segment neural network using the automatic layer-wise pruning process disclosed herein. In Table 2, the original unpruned example network included 9,356,616 parameters and 71,994,425,260 MAC operations. The different setups in Table 2 are intended to show a range of remaining parameters and MAC operations that may be obtained for an example neural network using the automatic layer-wise pruning process disclosed herein.

In Table 2, IoU stands for intersection-over-unit, which is used to assess performance (based on the standard Jaccard Index, commonly known as the PASCAL VOC intersection-over-union metric), and may be defined as

$$IoU = \frac{TP}{TP + FP + FN} , \qquad ( 6 )$$

in which TP, FP and FN respectively are the numbers of true positive, false positive, and false negative pixels determined over a whole test set. There are also two ways to categorize the data analyzed by the neural network: categories and classes. In Table 2, IoU_c may refer to classes or to categories. Classes are objects like “road,” “sidewalk,” “pole,” etc., whereas categories are “flat,” “nature,” “object,” etc. There is no clear distinction between classes and categories. It is simply a different way to categorize. Thus, the mean performance score is set forth as IoU_c in Table 2. Pixels labeled as void do not contribute to the score.

It is well-known that the global IoU measure is biased toward object instances that cover a large image area. In street scenes with strong scale variation, this can be problematic particularly for traffic participants, which are the key classes in a cityscape scenario. To evaluate how well individual instances in a cityscape scene are represented in labeling, a. semantic labeling is additionally evaluated using an instance-level intersection-over-union metric iIoU, which may be defined as

$$iIoU = \frac{iTP}{iTP + FP + iFN} , \qquad ( 7 )$$

in which iTP, FP and iFN respectively denote the numbers of true positive, false positive, and false negative pixels. In contrast to the standard IoU measure, however, iTP and iFN are determined by weighting the contribution of each pixel by the ratio of the average instance size of the class to the size of the respective ground truth instance.

As will be recognized by those skilled in the art, the innovative concepts described herein can be modified and varied over a wide range of applications. Accordingly, the scope of claimed subject matter should not be limited to any of the specific exemplary teachings discussed above, but is instead defined by the following claims.

What is claimed is:

1. A method to reduce computational load of a deep neural network, the method comprising:
determining a number of multiply-accumulate (MAC) operations for each layer l of the deep neural network, the deep neural network comprising a plurality of layers;
determining a pruning error allowance per weight ε* based on a computational load of a layer l;
for each layer l of the deep neural network;
initializing a threshold estimator Tₗ;
pruning weights of the layer l based on a standard deviation of all weights within the layer l;
determining a pruning error per weight ε for the layer l;
if |ε−ε|>θ, updating the threshold estimator Tₗ for the layer l in which θ is a predetermined number defining a range centered on the pruning error allowance per weight ε*, then
repruning weights of the layer l using the updated threshold estimator Tₗ, and
re-determining the pruning error weight ε until |ε−ε*|≤θ for the layer l; and if |ε−ε*|≤θ, retraining the deep neural network.

2. The method of claim 1, further comprising after retraining the deep neural network:
adjusting the threshold estimator Tₗ for each layer based on a MAC percentage value and a pruning percentage value; and
repruning and retraining the deep neural network.

3. The method of claim 1, wherein determining the pruning error allowance per weight ε* based on the computational load of a layer l comprises determining the pruning error allowance per weight ε* as
$${ɛ}^{*} = C + β \frac{{M}_{l}}{{\sum }_{l} {M}_{l}} ,$$
in which C is a constant and β is a weight value.

4. The method of claim 1, wherein pruning weights of the layer l based on the standard deviation of all weights within the layer l comprises pruning the weights of the layer l as
$${w}_{i} = \{ \begin{matrix}0 , & if \vert {w}_{i} \vert < {T}_{l} σ ( w ) \\ {w}_{i} , & else\end{matrix} ,$$
in which wᵢ is a weight of layer l, σ(w) is a standard deviation of all weights within a layer l, and w is a weight vector.

5. The method of claim 1, wherein determining the pruning error per weight ε comprises determining ε as
$$ɛ = \frac{{‖ {w}_{pruned} - w ‖}_{1}}{\vert 1 \{ wpruned == 0 \} \vert} .$$

6. The method of claim 1, wherein updating the threshold estimator Tₗ comprises updating the threshold estimator Tₗ as:
$${T}_{l} = \{ \begin{matrix}{T}_{l} + ζ , & if ɛ > {ɛ}^{*} + θ \\ {T}_{l} - ζ , & if ɛ < {ɛ}^{*} - θ\end{matrix} ,$$
in which ζ is a predetermined number by which the threshold estimator Tₗ may change.

7. The method of claim 1, wherein determining the pruning error allowance per weight ε* based on the computational load of a layer l comprises determining the pruning error allowance per weight ε* as
$${ɛ}^{*} = C + β \frac{{M}_{l}}{{\sum }_{l} {M}_{l}} ,$$
in which C is a constant and β is a weight value.

8. The method of claim 7, wherein pruning weights of the layer l based on the standard deviation of all weights within the layer l comprises pruning the weights of the layer l as
$${w}_{i} = \{ \begin{matrix}0 , & if \vert {w}_{i} \vert < {T}_{l} σ ( w ) \\ {w}_{i} , & else\end{matrix} ,$$
in which wᵢ is a weight of layer l, σ(w) is a standard deviation of all weights within a layer l, and w is a weight vector.

9. The method of claim 8, wherein determining the pruning error per weight ε comprises determining ε as
$$ɛ = \frac{{‖ {w}_{pruned} - w ‖}_{1}}{\vert 1 \{ wpruned == 0 \} \vert} .$$

10. The method of claim 9 wherein updating the threshold estimator Tₗ comprises updating the threshold estimator Tₗ as:
$${T}_{l} = \{ \begin{matrix}{T}_{l} + ζ , & if ɛ > {ɛ}^{*} + θ \\ {T}_{l} - ζ , & if ɛ < {ɛ}^{*} - θ\end{matrix} ,$$
in which ζ is a predetermined number by which the threshold estimator Tₗ may change.

11. The method of claim 10, further comprising after retraining the deep neural network:
adjusting the threshold estimator Tₗ for each layer based on a MAC percentage value and a pruning percentage value; and
repruning and retraining the deep neural network.
